(19) United States
(12) Patent Application Publication
(10) Pub. No.: US 2026/0038360 A1
(43) Pub. Date: Feb. 5, 2026

(54) METHOD AND SYSTEM FOR RATIONALIZING ALARMS

(71) Applicant: Honeywell International Inc., Charlotte, NC (US)

(72) Inventors: Srikant Srinivasan, Bangalore (IN); Senthilkumar Kumarasamy, Krishnagiri (IN); Karthick Manoharan, Bangalore (IN); Swetha Subramanian, Bangalore (IN); Sunkari Krishna, Bangalore (IN)

(21) Appl. No.: 18/791,478

(22) Filed: Aug. 1, 2024

(51) Int. Cl. G08B 29/18; G08B 29/22

(52) U.S. Cl. CPC G08B 29/185; G08B 29/22

(57) ABSTRACT

The present disclosure relates to a method for rationalizing alarms and tags in a control system. The method comprises steps of identifying one or more alarms associated with tags in the control system that require rationalization, creating an alarm template from existing alarm settings or selecting a predefined alarm template that includes standardized properties and values. The method further comprises applying the created or selected alarm template to the identified one or more alarms and selecting a source tag with rationalized alarm settings and copying the source tag properties, including at least one of alarm properties, boundary properties, and operational mode-specific settings. The method further comprises applying the copied source tag properties to one or more target tags and validating the applied target tags being consistent with the requirements of the control system.

### TECHNICAL FIELD

The present disclosure relates to industrial process control systems. More particularly, the present disclosure relates to methods and systems for optimizing and rationalizing alarms associated with industrial processes and assets.

### BACKGROUND

In the industrial process control environment, alarm systems are critical for notifying operators of abnormal situations that could result in equipment damage, operational disruptions, and substantial financial losses. These systems are essential for maintaining safety, efficiency, and productivity in industrial operations.

Despite their importance, alarm systems often face significant challenges. Common issues include frequent nuisance alarms, alarm floods, and inconsistent alarm prioritization. These problems can overwhelm operators, leading to missed critical alarms and potential hazards.

To address these challenges, periodic rationalization of alarms is crucial. This process involves reviewing and optimizing alarm settings, priorities, and response details to ensure the efficient operation of alarm management systems. However, rationalization is typically carried out by a small group of alarm experts, operators, and process engineers, who are also engaged in critical plant operations and production tasks. This makes the rationalization process labor-intensive and time-consuming, especially given the sheer volume of tags in an alarm system. For instance, for a control system with more than 20,000 tags that each contain 4-6 alarms, rationalizing just 20% of these alarms that may be identified as nuisance alarms can take more than 600 hours.

Conventional alarm rationalization techniques often involve reviewing every configurable alarm tag. However, historical analysis indicates that a quarter of these tags trigger all alarms over extended periods, while less than a fifth trigger more than 10 alarms. Thus, there is a need for methods that can efficiently identify alarm tags requiring rationalization.

Existing solutions, focus on optimizing alarms by establishing multi-level alarm configuration thresholds for monitoring parameters such as control intervals, alarm criticality, etc. These solutions filter process production data using these thresholds to reduce alarm frequency and operator workload. Nevertheless, the process of acquiring thresholds for the monitoring parameters may be time-consuming and complex.

Therefore, there exists a significant opportunity to improve alarm rationalization by developing tools that are simple, optimize time and resources, and improve the overall productivity and efficiency of alarm rationalization processes.

### SUMMARY

This disclosure provides a method and a system for rationalizing alarms and tags in a control system.

In an embodiment, a method for rationalizing alarms and tags in a control system is disclosed. The method includes identifying one or more alarms associated with tags in the control system that require rationalization and creating an alarm template from existing alarm settings or selecting a predefined alarm template that includes standardized properties and values. The method further includes applying the created or selected alarm template to the identified one or more alarms and selecting a source tag with rationalized alarm settings and copying the source tag properties, including at least one of alarm properties, boundary properties, and operational mode-specific settings. The method further includes applying the copied source tag properties to one or more target tags, where each tag is associated with one or more alarms, and validating the applied target tags being consistent with the requirements of the control system.

In some embodiments, the method further comprises auditing the changes made to each tag or alarm, capturing details of the applied template or copied properties and the source of the changes.

In some embodiments, the standardized properties and values include one or more of alarm response details, priority levels, and operational modes.

In some embodiments, applying the created or selected alarm template to the identified one or more alarms may comprise selecting the alarms or tags to which the template is to be applied, searching the template to ensure it meets a required threshold and applying the template with a minimal number of user interactions to standardize the alarm settings across the selected alarms or tags.

In some embodiments, applying the created or selected alarm template to the identified one or more alarms comprises selecting the alarms or tags to which the template is to be applied, searching the template to ensure it meets a required threshold, and applying the template with a minimal number of user interactions to standardize the alarm settings across the selected alarms or tags.

In some embodiments, applying the copied source tag properties to one or more target tags comprises selecting the target tags for applying the copied properties, providing flexibility to choose specific properties from the copied properties to be applied to the target tags, and executing the paste operation to replicate the rationalized settings from the source tag to the target tags.

In some embodiments, applying the copied source tag properties to one or more target tags includes displaying the alarms and mode of operation to be copied for individual tags.

In some embodiments, applying the copied source tag properties to one or more target tags includes checking if variable tags belong to the same alarm system.

In some embodiments, auditing the changes made to each tag or alarm includes auditing the created or selected alarm template.

In some embodiments, the created template is flexible to include only specific modes of operations and specific alarm types.

In some embodiments, the template may be created from a released copy of a variable or a newly created or modified release copy of the variable.

In yet another embodiment, an alarm management system for rationalizing alarms in a control environment is disclosed. The alarm management system includes a memory and a processor configured to be operatively associated with the memory. The process is configured to identify one or more alarms associated with tags in the control system that require rationalization, and create an alarm template from existing alarm settings or select a predefined alarm template that includes standardized properties and values. The processor is further configured to apply the created or selected alarm template to the identified one or more alarms, select a source tag with rationalized alarm settings, and copy the source tag properties, including at least one of alarm properties, boundary properties, and operational mode-specific settings. Furthermore, the processor is configured to apply the copied source tag properties to one or more target tags, where each tag is associated with one or more alarms, and validate the applied target tags being consistent with the requirements of the control system.

In some embodiments, the processor is further configured to audit the changes made to each tag or alarm, and capture details of the applied template or copied properties and the source of the changes.

In some embodiments, the system includes standardized properties and values including one or more of alarm response details, priority levels, and operational modes.

In some embodiments, the processor is further configured to apply the created or selected alarm template to the identified one or more alarms by selecting the alarms or tags to which the template is to be applied, searching the template to ensure it meets the required threshold and applying the template with a minimal number of user interactions to standardize the alarm settings across the selected alarms or tags.

In some embodiments, the processor is further configured to apply the copied source tag properties to one or more target tags by selecting the target tags for applying the copied properties, providing flexibility to choose specific properties from the copied properties to be applied to the target tags, and executing the paste operation to replicate the rationalized settings from the source tag to the target tags.

In some embodiments, the processor is further configured to display the alarms and mode of operation to be copied for individual tags.

In some embodiments, the processor is further configured to check if variable tags belong to same alarm system.

In some embodiments, to audit the changes made to each tag, the processor is further configured to audit the created or selected alarm template.

In some embodiments, the created template is flexible to include only specific modes of operations and specific alarm types.

In yet another embodiment, a non-transitory computer-readable medium having stored thereon computer-readable instructions is disclosed. The computer-readable instructions that, when executed by a processor, cause the processor to execute a method for rationalizing alarms and tags in a control system, includes identifying one or more alarms associated with tags in the control system that require rationalization. The computer-readable instructions also include creating an alarm template from existing alarm settings or selecting a predefined alarm template that includes standardized properties and values. The computer-readable instructions also include applying the created or selected alarm template to the identified one or more alarms. The computer-readable instructions further include selecting a source tag with rationalized alarm settings and copying the source tag properties, including at least one of alarm properties, boundary properties, and operational mode-specific settings. The computer-readable instructions further include applying the copied source tag properties to one or more target tags, where each tag is associated with one or more alarms, and validating the applied target tags being consistent with the requirements of the control system.

The disclosed alarm rationalization method and system offer a sophisticated approach to managing alarms in complex industrial processes, enhancing operational efficiency and safety. The method begins with the comprehensive collection and analysis of alarm data from various sensors and actuators within the process control system. This data is processed to identify patterns and trends, such as frequently occurring alarms or alarms with low significance. By employing advanced algorithms, the system can classify and prioritize alarms based on their frequency, duration, and impact. This initial step is crucial in reducing the incidence of nuisance alarms that can overwhelm operators and lead to potential oversight of critical issues.

Once the alarms requiring rationalization are identified, the system generates templates for alarm settings at both the tag level and the alarm level. These templates are customizable, allowing operators to fine-tune alarm configurations based on specific operational needs. The system supports copying and pasting of alarm configurations, facilitating rapid deployment of optimized settings across multiple assets. This ensures a standardized approach to alarm management, which is essential for maintaining consistency and reliability in large-scale industrial environments. After applying the new alarm settings, the system continuously monitors their effectiveness, providing real-time feedback and enabling further adjustments as necessary. This iterative process ensures that the alarm system remains efficient and effective, significantly reducing the time and effort required for manual alarm rationalization.

Moreover, the integration of the alarm rationalization device within the broader process control system highlights its versatility and adaptability. The device, which can be part of an operator console or server, interacts seamlessly with other components such as controllers, sensors, and actuators. This integration enables comprehensive oversight and proactive management of operational conditions, contributing to the overall reliability and safety of industrial operations. The method and system described not only streamline alarm management but also enhance the decision-making capabilities of operators, ultimately leading to improved productivity and operational performance across various industrial sectors.

Other technical features may be readily apparent to one skilled in the art from the following figures, descriptions, and claims.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF THE DRAWINGS

For a more complete understanding of this disclosure and its features, reference is now made to the following description, taken in conjunction with the accompanying drawings, in which:

FIG. 1(a) illustrates an exemplary process control system, showcasing the integration of alarm rationalization tools within the broader operational framework, according to an embodiment of the disclosure;

FIG. 1(b) illustrates an alarm rationalization device according to an embodiment of the disclosure;

FIG. 2 illustrates a flowchart of a method for alarm rationalization using an alarm rationalization tool according to an embodiment of the disclosure;

FIGS. 3(a)-(s) illustrate example details associated with an alarm rationalization method according to one or more embodiments of this disclosure;

FIG. 4 illustrates an alarm rationalization system according to an embodiment of the disclosure; and

FIG. 5 illustrates a schematic diagram of a communication apparatus according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

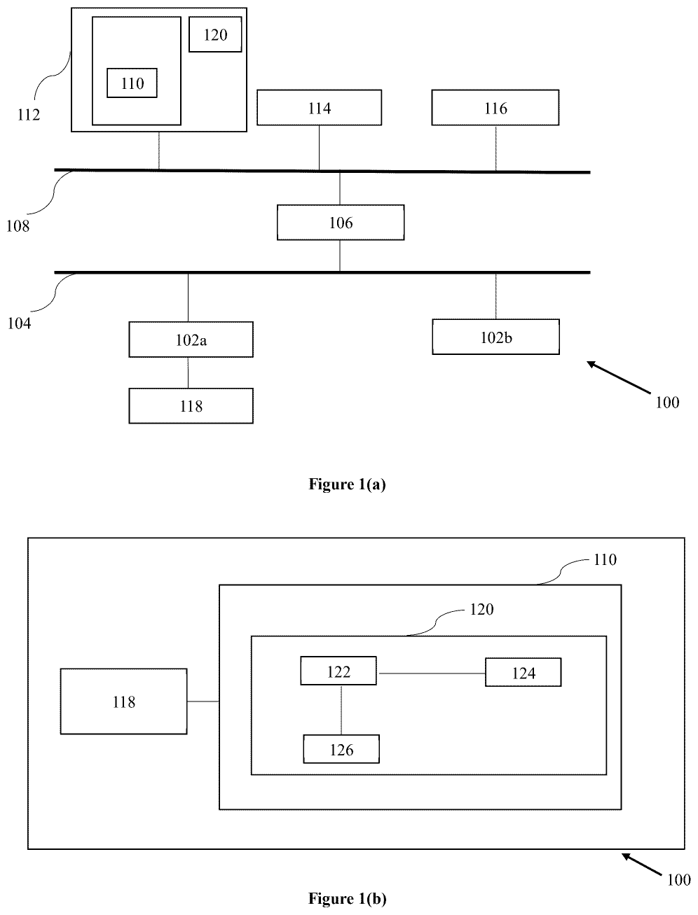

FIG. 1(a) illustrates an exemplary process control system 100, hereinafter interchangeably referred to as “a control system 100”, “a process system 100”, or “a system 100”, according to an embodiment of the disclosure. The process control system 100 includes various components, including but not limited to, one or more sensors 102a and one or more actuators 102b. The sensors 102a and actuators 102b represent components in the process system 100 that may perform any of a wide variety of functions. For example, the sensors 102a could measure a wide variety of characteristics in the process control system 100, including but not limited to, temperature, pressure, vibration or flow rate. The actuators 102b on the other hand, may perform a wide variety of operations that change the characteristics being measured by the sensors 102a. In an exemplary embodiment, the actuators 102b could include electrical motors, hydraulic cylinders, or transducers. In an embodiment, the sensors 102a and the actuators 102b could represent any other or additional components in any suitable process system. The process control system 100 may generally represent any system or portion thereof configured to process one or more products or other materials in some manner.

In an embodiment, the sensors 102a and the actuators 102b are connected to at least one network 104, which helps the sensors 102a and the actuators 102b communicate and operate together. In an exemplary embodiment, the network 104 could transport measurement data from the sensors 102a and sends control signals to the actuators 102b. The network 104 could represent any suitable network or combination of networks. For example, the network 104 could represent an Ethernet network, an electrical signal network, (including but not limited to, a HART or FOUNDATION FIELDBUS network), a pneumatic control signal network, or any other or additional type(s) of network(s).

The process control system 100 also includes assets 118. In an embodiment, an asset 118 may be any machinery, equipment, or system within a site for which alarms may be used to monitor its functionality. In an exemplary embodiment, the assets 118 include, but are not limited to, storage tanks, air conditioning units, chemical reactors, distillation columns, boilers, heat pumps, drainage systems, hydraulic presses, fans, radiators, plumbing systems, air purification systems, etc. In an embodiment, the assets 118 may be connected to the sensors 102a that could measure a wide variety of characteristics related to assets including, but not limited to, pressure, temperature, or flow rate. In an alternate embodiment, the sensors 102a may be configured within the assets 118.

The process control system 100 also includes various controllers 106. The controllers 106, among other things, use the measurement data from one or more sensors 102a to control the operation of the one or more actuators 102b. For example, the controllers 106 could receive data from the one or more sensors 102a and then use this data to generate control signals for the operation of the one or more actuators 102b. In an embodiment, each of the controllers 106 includes any suitable structure for controlling one or more aspects of an industrial process. The controllers 106 could, for example, represent multivariable controllers, proportional-integral-derivative (PID) controllers or other types of controllers that implement specific control logic such as logic linking sensor measurement data to actuator control signals. Each of the controllers 106 could, for example, represent a computing device running a real-time operating system, a WINDOWS operating system, or other operating system.

The controllers 106 can communicate via one or more networks 108, including buses and associated switches, firewalls, and other components. The networks 108 facilitate interaction with the controllers 106, such as by transporting data to and from the controllers 106.

The process control system 100 also includes at least one or more servers 116 and one historian 114. The one or more servers 116 are coupled to the networks 108 and perform numerous functions to support the operation and control of the controllers 106, sensors 102a, and actuators 102b. For example, the one or more servers 116 could log information collected or generated by the controllers 106, such as measurement data from the sensors 102a or control signals for the actuators 102b. The one or more servers 116 could also execute applications that control the operation of the controllers 106, thereby controlling the operation of the actuators 102b. Each of the servers 116 includes any hardware, software, firmware, or combination thereof for providing access to, control of, or operations related to the controllers 106. In an exemplary embodiment, each of the servers 116 could represent a computing device running a WINDOWS operating system or other operating system.

The historian 114 generally represents a component that collects information about the working of the system. The historian 114 may, for instance, collect measurement data associated with the operation of the sensors 102a. The historian 114 may also collect control data provided to the actuators 102b. The historian 114 may collect any other or additional information associated with the process control system 100, such as alarms generated in the system and operator actions taken in response to the alarms. The historian 114 may, for instance, collect information that is generated by the various controllers 106 during the control of one or more industrial processes, such as actual alarms operator actions taken in response to the alarms. The historian 114 includes any suitable structure for storing and facilitating retrieval of information. Although shown as a single component here, the historian 114 could be located elsewhere in the system, or multiple historians could be distributed in different locations in the system.

One or more operator consoles 110 are coupled to the networks 108. The operator consoles 110 are computing or communication devices that enable users to access the servers 116, which could then provide user access to the controllers 106, sensors 102a, and actuators 102b. For example, the operator consoles 110 could allow users to review the operational history of the sensors 102a and the actuators 102b using data collected by the controllers 106 and/or the servers 116. The operator consoles 110 could also allow the users to adjust the operation of the sensors 102a, actuators 102b, controllers 106, or servers 116. Additionally, the operator consoles 110 could receive and display warnings, alerts, or other messages or displays generated by the controllers 106 or the servers 116. Each of the operator consoles 110 includes any hardware, software, firmware, or combination thereof for supporting user access and control of the system. Each of the operator consoles 110 could, for example, represent a computing device running a MICROSOFT WINDOWS operating system.

In an embodiment, multiple operator consoles 110 can be grouped and used in one or more control rooms 112. Each control room 112 could include any number of operator consoles 110 in any suitable arrangement. In some embodiments, multiple control rooms 112 can be used to control an industrial plant, such as when each control room 112 contains operator consoles 110 used to manage a discrete part of the industrial plant.

In an embodiment, the operator console 110 is in communication with at least one alarm rationalization device 120. For example, the communication may be over wireless channels or wired channels or a combination thereof. Examples of communication may include but are not limited to the internet, a local area network (such as, a TCP/IP based Network, an ETHERNET-based local area network, an ETHERNET-based personal area network, a Wi-Fi network, and the like), Wide Area Networks (WANs), Metropolitan Area Network (MANs), a telecommunication network, and a radio network.

The alarm rationalization device 120 could be executed by any suitable component(s) in the system 100 including, but not limited to, one or more servers or operator stations or executed outside of the system 100.

Various devices shown in FIG. 1(a) can generate alarms for users, such as when the controllers generate alarms when values of process variables associated with an industrial process are outside of their respective limits. Industrial processes are typically associated with hundreds or thousands of process variables, which can include controlled, manipulated, and disturbance variables. A controlled variable generally denotes a variable whose value can be measured or inferred and that is controlled to be at or near a desired setpoint or within a desired range. A manipulated variable generally denotes a variable that can be altered in order to adjust one or more controlled variables. A disturbance variable generally denotes a variable whose value can be considered but not controlled when determining how to adjust one or more manipulated variables to achieve desired changes to one or more controlled variables.

Although FIG. 1(a) illustrates one example of an industrial process control system 100, various changes may be made to FIG. 1(a). For example, the system 100 could include any number of sensors, actuators, controllers, networks, operator stations, control units, historians, servers, and other components. Also, the arrangement of the system 100 in FIG. 1(a) is for illustration only. Components could be added, omitted, combined, further subdivided, or placed in any other suitable configuration according to particular needs. Further, particular functions have been described as being performed by particular components of the system 100. This is for illustration only. In general, control systems are highly configurable and can be configured in any suitable manner according to particular needs. In addition, FIG. 1(a) illustrates one example operational setting where alarm rationalization techniques could be used. This functionality can be used in any other suitable system.

FIG. 1(b) illustrates an alarm rationalization device 120, hereinafter interchangeably referred to as “a device 120”, supporting the rationalization and resolution of alarms in an industrial process control system 100 according to an embodiment of this disclosure. For case of explanation, the device 120 may be described as being used in the system 100 of FIG. 1(a). The device 120 could, for example, denote an operator console 110 or a server 116 as shown in FIG. 1(a). However, the device 120 could be used in any other suitable system.

As shown in FIG. 1(b), the device 120 includes at least one processor 122, at least one memory 124, and at least one input/output unit (I/O unit) 126. The processor 122 is configured to access the memory 124 and execute computer-readable instructions, such as those that may be loaded into the memory 124. These instructions could implement the alarm rationalization method described in this disclosure. The processor 122 denotes any suitable processing device, including but not limited to, one or more microprocessors, microcontrollers, digital signal processors, application specific integrated circuits (ASICs), field programmable gate arrays (FPGAs), or discrete circuitry. The memory 124 is used for storing instructions and data used, generated, or collected by the processor(s). The memory 124 may represent a random access memory or any other suitable volatile or non-volatile storage device(s).

The I/O unit 126 facilitates both input and output of data. For example, the I/O unit 126 enables user interaction through various input devices, including but not limited to, a keyboard, mouse, keypad, touchscreen, or other suitable input device. Additionally, the I/O unit 126 may also transmit data output to a display, printer, or other suitable output device.

Each asset 118, as shown in FIG. 1(b), within the system 100 is associated with one or more tags or measurements, which may trigger alarms when certain configured parameters are exceeded. These alarm tags can represent parameters like temperature, pressure, flow rate, or the operational status of equipment. For instance, if an asset 118 stops working or if its measurements deviate from expected or desired performance ranges, an alarm associated with its tag is activated. For example, consider an asset, which could be a liquid tank with an anticipated fill level of 80%. If the fill level surpasses 85%, an alarm would be triggered. This ensures timely notification to operators or maintenance personnel, enabling prompt response to potential issues before they escalate. As used herein, the terms “alarm tags” or “tags” may be used interchangeably.

Each tag can be associated with multiple types of alarms to cover different scenarios and levels of urgency. A tag representing a single temperature reading might have, for example, not only a “High” value alarm but also a “High-High” value alarm, a “Low Value” alarm, a “Low-Low” alarm, a rate-of-change alarm, an alarm indicating the signal has moved outside of a known range, and several other types. These alarms can be prioritized based on their importance or criticality, aiding operators in efficiently managing and responding to alarms as they occur.

In complex industrial processes, where numerous assets and parameters are monitored simultaneously, the use of alarm tags ensures comprehensive oversight and proactive management of operational conditions. This integration of alarms with tags forms a fundamental aspect of industrial automation and control systems, contributing significantly to operational reliability and safety across various industrial sectors.

However, for the effective management and rationalization of alarm system in large-scale industrial plants, it can take thousands of man-hours to analyse an alarm system to provide functional and/or effective changes to increase industrial process efficiency and/or safety. For example, an industrial control system with more than 20,000 tags that each contain 4-6 alarms can take more than 600 man-hours to review just 20% of the alarms. Typically, a specialized group of alarm experts or subject matter experts are tasked with the responsibility of rationalising of alarms. The expertise and effectiveness of these individuals directly impact the overall efficiency and performance of industrial processes as these professionals are concurrently engaged in critical activities such as plant operations and production.

Thus, to address these and/or other issues, various embodiments of the present disclosure relate to methods for rationalizing alarms and tags in a control system, by identifying alarms that require rationalization and creating templates at alarm level and tag level, copying and pasting of tags. These features disclosed in the present disclosure will make the rationalizing process more efficient, productive and in standardization across enterprise. For instance, in an embodiment, an automated system analyzes historical alarm data, identifies patterns of nuisance alarms, and recommends adjustments to alarm settings or priorities. In another embodiment, a user interface may allow operators to easily review and adjust alarm configurations, potentially integrating machine learning algorithms to predict and prevent alarm floods.

Although FIG. 1(b) illustrates one example of a device 120 supporting the rationalization of alarms in an industrial process control system, various changes may be made to FIG. 1(b). For example, components could be added, omitted, combined, further subdivided, or placed in any other suitable configuration according to particular needs. Also, FIG. 1(b) does not limit this disclosure to any particular configuration of alarm rationalization device 120.

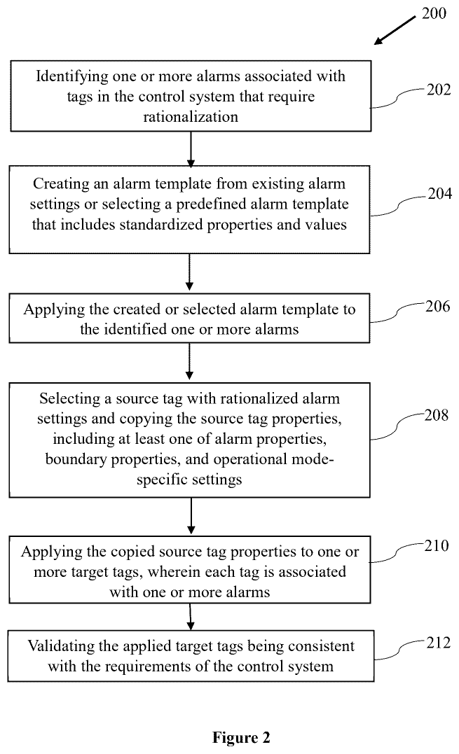

FIG. 2 is a flowchart illustrating alarm rationalization method 200 according to an embodiment of this disclosure. For ease of explanation, the method 200 is described with respect to the alarm rationalization device 120 operating in conjunction with the process control system 100 of FIG. 1(a). The method 200 could be used with any suitable device and in conjunction with any suitable system.

The method 200 comprises identifying one or more alarms associated with tags in the control system 100 that require rationalization, step 202. This could include, for example, identifying one or more alarms or tags that are nuisance alarms, such as chattering, fleeting, bad actors (most frequent) alarms, etc. The chattering alarms refer to those alarms that frequently switch state between active and inactive in a short period of time. The fleeting alarms are alarms that activate and deactivate so quickly that they barely register with the operator. Further, the bad actor alarms are alarms that are frequently or consistently activated by specific conditions or events that are not true indications of a problem.

In an embodiment, the method further includes identifying alarm floods or improper priority distribution. The alarm flood is defined by ISA-18.2 as more than 10 alarms annunciating in a 10-minute period. When the alarm flood contains hundreds or even thousands of alarms in a few minutes, the operator can be set up to fail by being overwhelmed by alarms and completely missing alarms or by being distracted by the noise and activity. Improper priority distribution is alarms with incorrect priority or the presence of invalid alarms.

The method further comprises creating the alarm template from existing alarm settings or selecting a predefined alarm template that includes standardized properties and values, step 204. An alarm template, for example, is a predefined configuration that simplifies the setup and customization of alarms within a system. It encapsulates essential parameters including but not limited to, limits, severities, and notification settings, offering a standardized approach to handling alarms effectively. The alarm template includes crucial alarm configuration details, for example, high and low thresholds that trigger the alarm, the level of urgency or impact of the alarm, e.g., low, medium, high and notification settings i.e. who receives the alarm notifications and how they are delivered.

In an embodiment, templates may be created from an existing alarm system, such that the user can select the existing alarm to be converted to a template. The alarm template may include a name, description and search context. These details help categorize and identify the template for future use. Users also have the option to choose which specific properties of the alarm should be included in the template like response fields, value fields etc.

In an embodiment, the templates may be created by selecting a predefined alarm template that includes standardized properties and values. The standardized properties and values include one or more of alarm response details, priority levels, and operational modes. Alarm response details may refer to the actions taken by operators in response to an alarm signal in an industrial setting including but not limited to, time to respond or action(s) taken to resolve the alarm priority levels which may indicate a priority of the particular alarm. Example priorities include low, medium, high, and urgent. The modes of operation include, but not limited to, base mode and non-base mode. In an embodiment, the base mode represents the primary or default operating condition of the alarm system or equipment. Alarms configured in the base mode are set to trigger when the system or equipment deviates from its normal or expected operating parameters. Further, the term “non-base mode” refers to operating conditions or modes of a system that are not the standard or default setting. In alarm management systems, non-base modes would be any operational states that differ from the normal operating mode and may require different alarm settings or responses.

In alarm rationalization, the base mode values are used as a reference for configuring alarms and may be inherited by other modes of operation to ensure consistency and standardization across different areas or units within a facility. It is essential for the alarm system to notify operators of abnormal situations that require action to prevent undesired consequences, and base mode settings play a crucial role in this process.

The method further includes applying the created or selected alarm template to the identified one or more alarms, step 206. For applying the alarm templates, the users select the alarms or tags to which the template is to be applied. In an embodiment, the method further includes searching the template to ensure it meets a required threshold, for example, users can search for templates based on criteria such as name, description, or search tag. The search tag is a field where the user enters some template-related words. The list of templates matching the search criteria is generated. Optionally, users may preview each template if needed.

In an embodiment, the method further includes applying the template with a minimal number of user interactions to standardize the alarm settings across the selected alarms or tags.

In an embodiment, the created template is flexible to include only specific modes of operations and specific alarm types. The alarm types are a High-High value alarm, a “Low Value” alarm, a “Low-Low” alarm, a rate-of-change alarm, an alarm indicating the signal has moved outside of a known range, and several other types.

It should be understood by a person skilled in the art that templates at tag level (tag templates) are created in a similar manner as alarm templates according to this disclosure. Accordingly, all the features of alarm templates are applied to tag templates.

Users may edit or modify the properties of alarm templates and tag templates created. Customizing templates within and across different sites helps in standardization in alarm settings and responses. Various properties of alarm templates and tag templates may be edited or modified or deleted depending on the requirement.

The method further includes selecting a source tag with rationalized alarm settings and copying the source tag properties, including at least one of the alarm properties, boundary properties, and operational mode-specific settings, step 208. In an embodiment, the alarm properties include, but not limited to, priority levels (e.g., high, medium, low) to indicate the urgency of response required and category. Higher priority alarms demand immediate attention to prevent safety hazards or equipment damage. Further, alarms can be categorized based on their nature, such as process alarms (related to operational parameters like temperature, and pressure), equipment alarms (related to machinery faults or failures), or safety alarms (indicating potentially hazardous conditions).

In an embodiment, boundary properties of an alarm define the conditions under which alarms activate or deactivate, ensuring that they accurately reflect operational thresholds and deviations. These include, but are not limited to, set points, alarm bands, etc. For example, set points which are predefined thresholds that, when exceeded, trigger an alarm. Set points can be static or dynamically adjusted based on operational conditions and process requirements. The alarm band prevents alarms from toggling rapidly around a set point due to minor fluctuations or noise in sensor readings. It ensures stability and reduces false alarms by specifying a range within which the alarm remains active or inactive after activation or deactivation.

Operational mode-specific settings customize alarm behaviour based on different operational states or modes. The operational modes include, but are not limited to, normal operation, startup/shutdown stages, maintenance mode and emergency situations. In normal operation, alarms are configured to detect deviations that may indicate emerging issues requiring attention or adjustment to maintain optimal performance. In startup and shutdown mode, the transitions between operational modes (startup/shutdown) in chemical processes generate alarm floods and cause critical alarm saturation. In maintenance mode, alarms may be temporarily suppressed or adjusted during maintenance activities to prevent unnecessary alarms triggered by intentional deviations from normal operating conditions. In emergency mode, alarms are configured to prioritize critical safety alarms and provide clear, immediate notifications to operators and emergency response teams, facilitating swift and effective actions to mitigate risks.

The user identifies and selects the source tag for which the rationalization process is completed. This source tag will serve as the reference point for the values and properties that is copied to the target tag.

The method further includes applying the copied source tag properties to one or more target tags, where each tag is associated with one or more alarms, step 210. Users select the target tags for applying the copied properties. The criteria for selecting the target tag includes selecting tags that serve a similar function or role within the unit or system, tags that measure similar parameters or share redundant measurement units and tags that trigger similar alarms or alerts based on their measurements. Within a unit, there can be similar alarms or tags (measurements). These similar tags may share characteristics or properties that can be rationalized or standardized which ensures consistency and efficiency in managing tags across the system. During the process of applying the copied properties, the rationalized values, or properties from the source tag are accurately copied to the selected target tags.

The method further comprises providing flexibility to choose specific properties from the copied properties to be applied to the target tags. In an embodiment, the users have the flexibility to choose specific properties from the copied properties of the source tag to be copied onto the target tags. Properties are categorized into groups like “Variable”, “Alarms”, “Boundaries”, “Variable Properties”, “Variable Notes”, and “Other parameters”. The categorization of alarm properties simplifies the selection process, making it easier for the users to find and apply relevant properties. The variable refers to the data points or tags that are monitored by the alarm system. Each variable can have different properties and alarm settings. Alarms are the notifications triggered when a variable deviates from its normal operating range. Alarms alert operators to take corrective action. Boundaries define the limits within which a variable should operate. Crossing these boundaries triggers an alarm. Variable properties are the attributes or settings associated with a variable. Variable notes related to a variable that provides information such as purpose of measurement, verification, etc.

In some examples, depending on the operational needs or system requirements, users are also provided with options to either paste values from the source tag into all applicable properties (tag properties, alarm properties, or boundary properties) or selectively choose which fields to copy. Optionally, the option to bulk select all, deselect all, and partial select is also provided.

The method further comprises executing the paste operation to replicate the rationalized settings from the source tag to the target tags. Once the fields are selected, the paste operation is performed, transferring the values from the source tag to the target tags. Before pasting the copied properties, users can preview which alarms and what mode of operation data will get copied for each individual tag.

In an embodiment, applying the copied source tag properties to the one or more target tags includes displaying the alarms and mode of operation to be copied for individual tags. This step implies that before pasting the copied properties, users can preview which alarms and what mode of operation data will get copied for each individual tag.

In another embodiment, applying the copied source tag properties to the one or more target tags includes checking if variable tags belong to the same alarm system. Variable tags are used in reference to alarm properties.

The method further comprises validating the applied target tags being consistent with the requirements of the control system, step 212. In an embodiment, the validation of the applied target tags involves that only appropriate and correct source tag properties are copied to the target tag. If any of the copied properties is not applicable for copying to a particular target tag, then that property will be discarded.

In an embodiment, the method further comprises auditing the changes made to each tag or alarm, capturing details of the applied template or copied properties and the source of the changes. The method further includes auditing changes made during the application of templates to target variables, capturing detailed information about the source template applied or copied properties of the source tag.

In an embodiment, the alarm rationalization method includes decommissioning of alarms, aimed at improving the efficiency and reliability of alarm management. Decommissioning involves the systematic review and removal of alarms that are no longer relevant or necessary for the operation of the plant. This process is essential for minimizing the burden on operators, reducing nuisance alarms, and ensuring that only the most critical alarms remain active, thereby enhancing the overall safety and productivity of the industrial environment.

According to an embodiment, the process of decommissioning alarms is integrated within the alarm rationalization device 120, as illustrated in FIG. 1(b). The device's processor 122 accesses historical alarm data stored in the memory 124 and collected by the historian 114 of the process control system 100. Using this data, the device identifies alarms that have not been triggered for an extended period or have been deemed redundant due to changes in operational procedures or equipment configurations. The input/output unit 126 facilitates the interaction between the alarm rationalization device and the operator consoles 110, allowing operators to review and approve the decommissioning of identified alarms.

In an embodiment, the system collects and analyzes historical alarm data to identify candidates for decommissioning. This involves evaluating the frequency, duration, and context of each alarm event to determine its relevance. Alarms that consistently fall below a predefined threshold for activation or importance are flagged for decommissioning. Operators are then presented with a list of these alarms through the operator consoles 110, where they can further analyze the alarms' history and decide on their decommissioning. The decision-making process is supported by detailed reports generated by the device, highlighting the impact of decommissioning specific alarms on overall system performance and safety.

Once an alarm is approved for decommissioning, the device updates the configuration of the controllers 106, sensors 102a, and actuators 102b to remove the decommissioned alarms. This update is propagated through the networks 104 and 108, ensuring that all relevant components of the process control system 100 are synchronized with the new alarm configuration. The decommissioned alarms are logged and archived by the historian 114 for future reference, ensuring traceability and compliance with regulatory requirements. This methodical approach to decommissioning alarms not only streamlines alarm management but also enhances the operational integrity of the industrial process control system, reducing the likelihood of operator overload and ensuring that critical alarms receive the necessary attention.

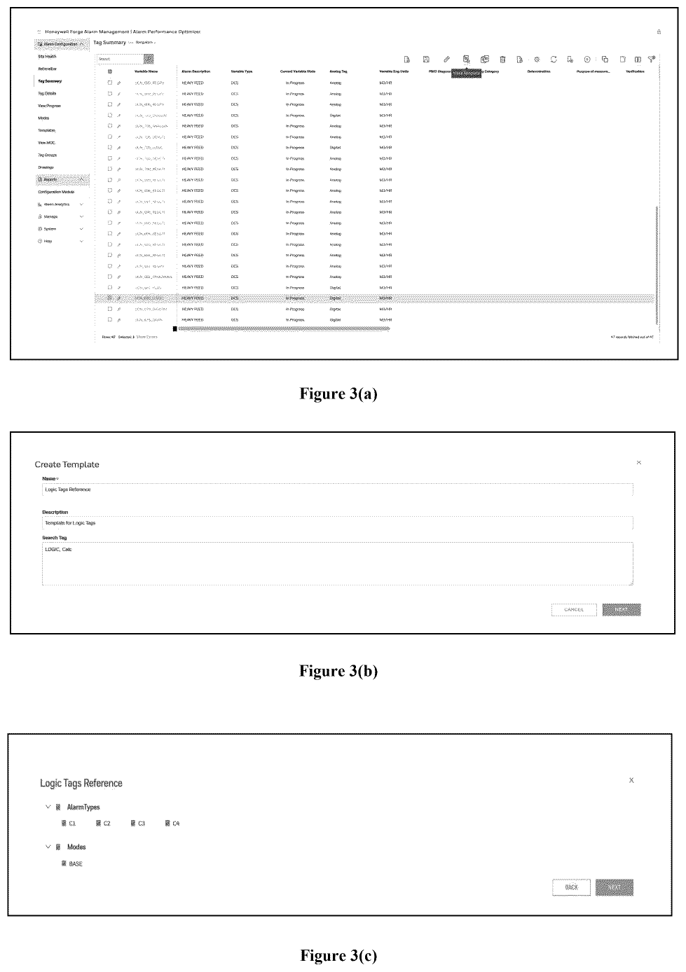

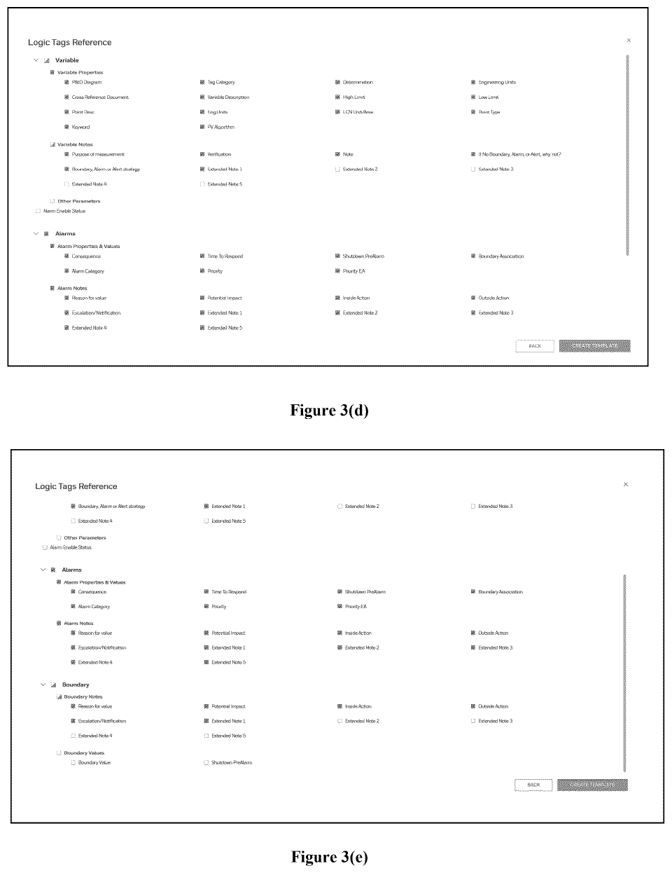

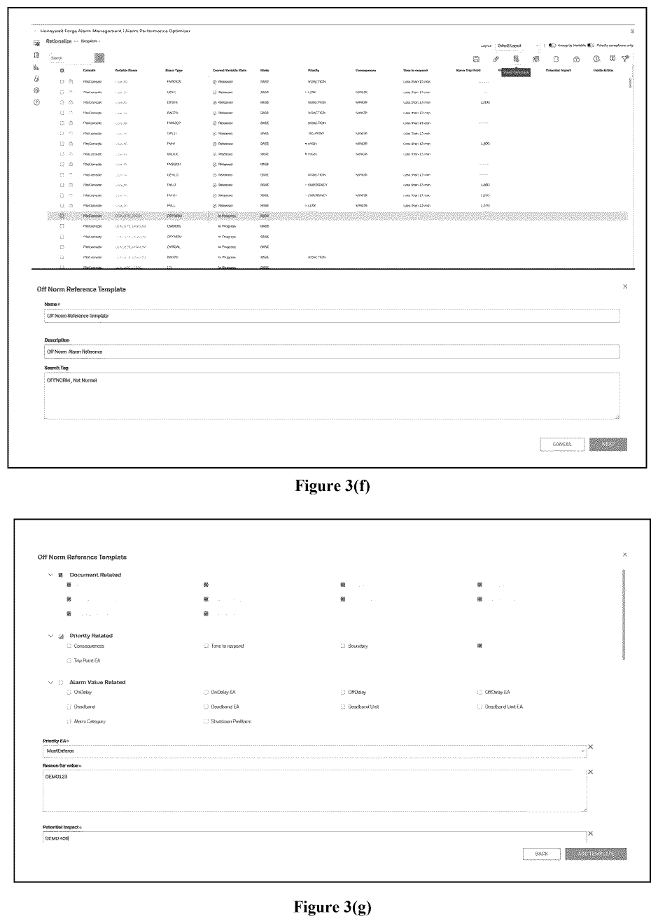

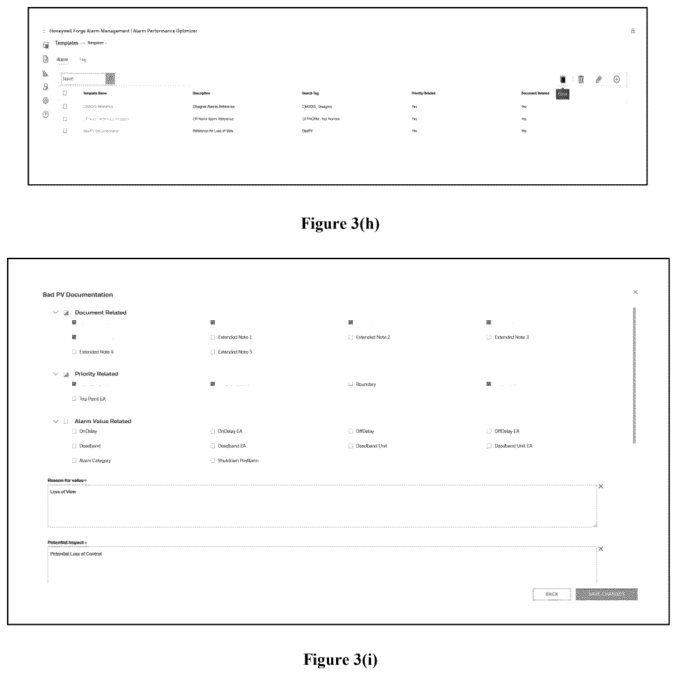

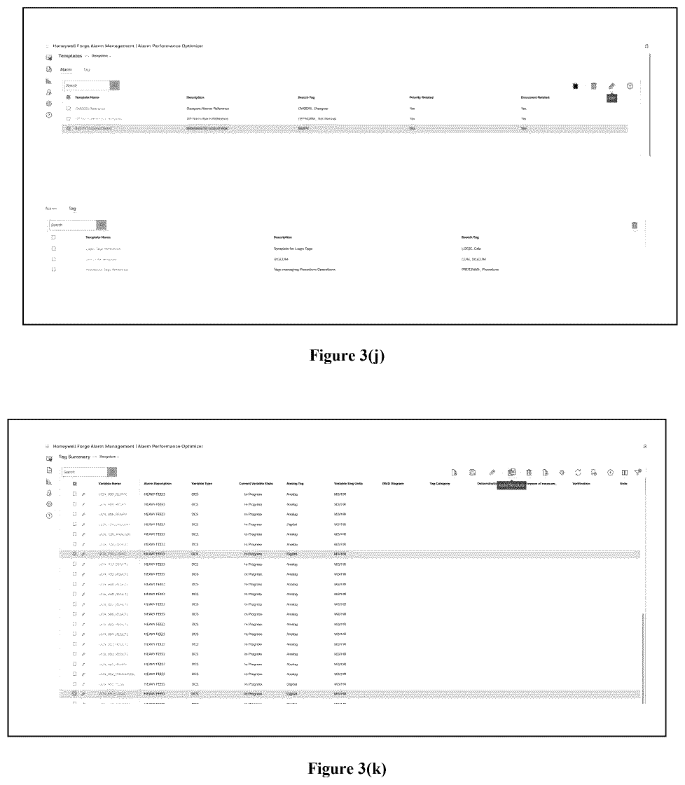

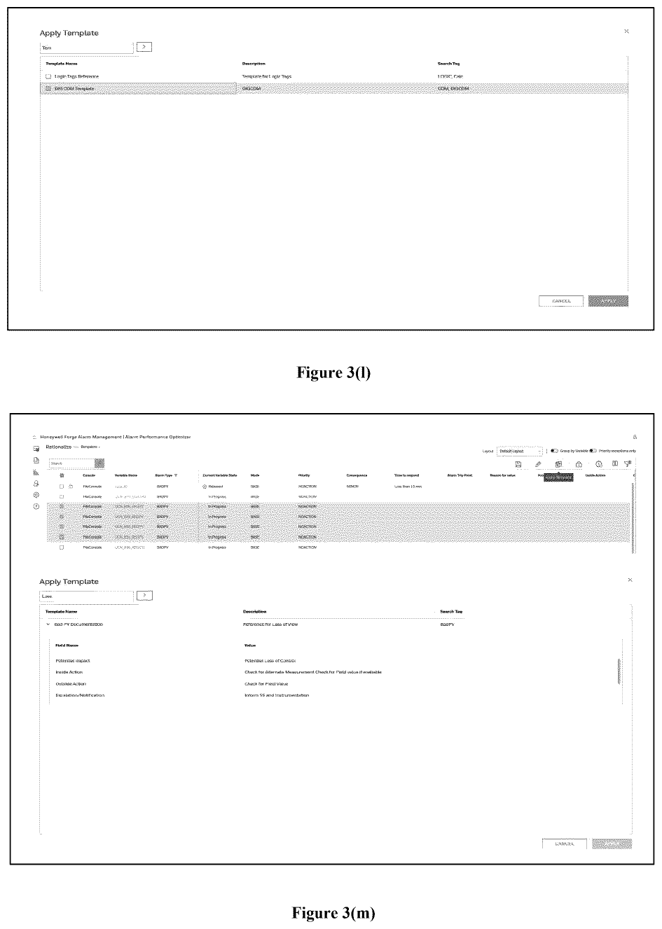

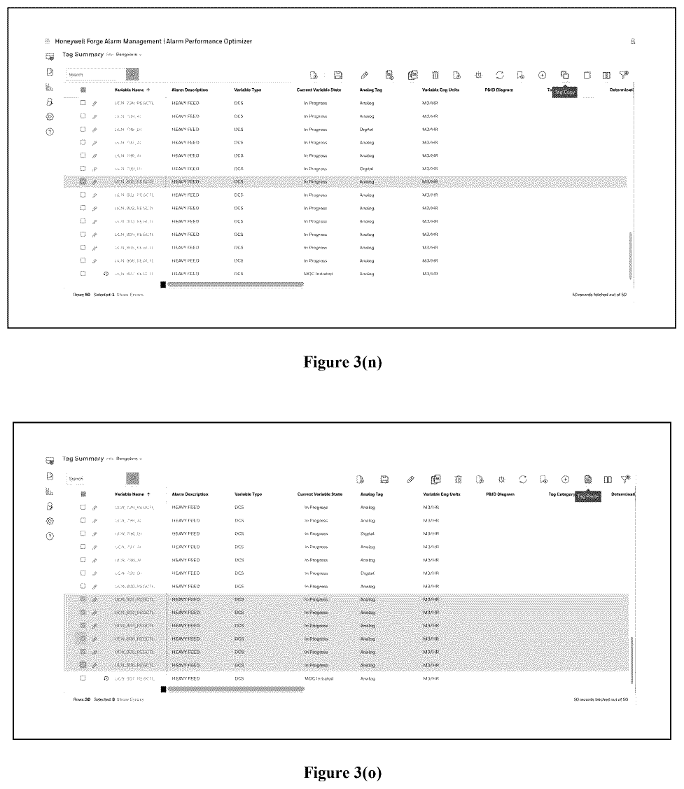

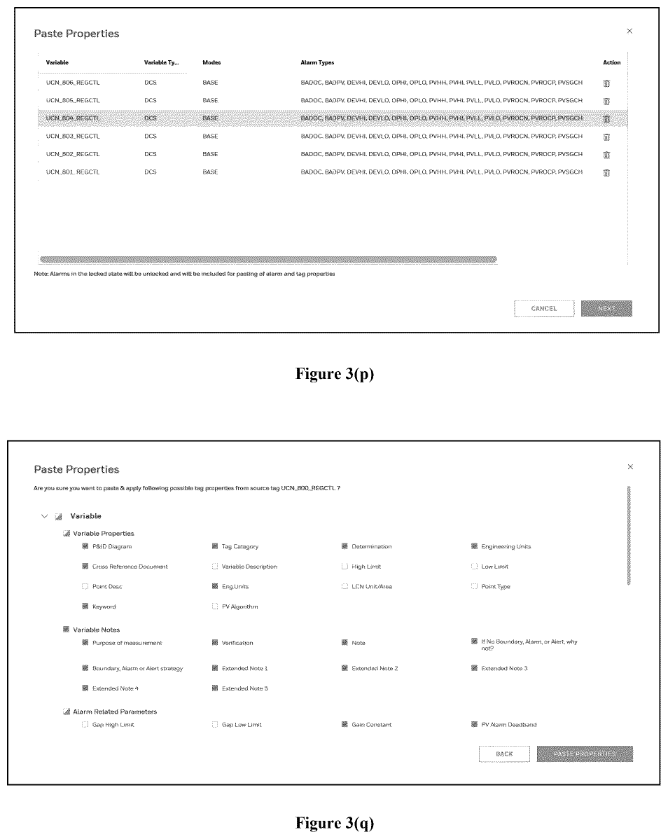

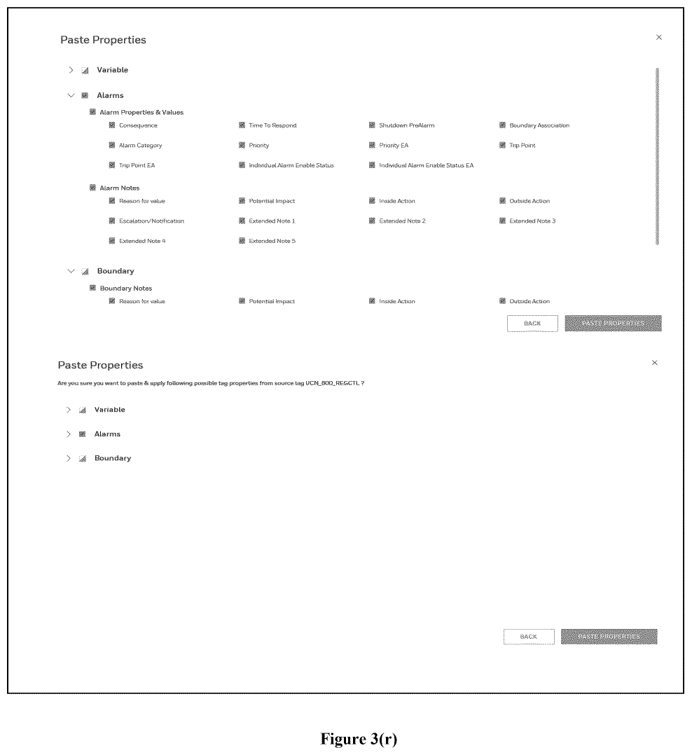

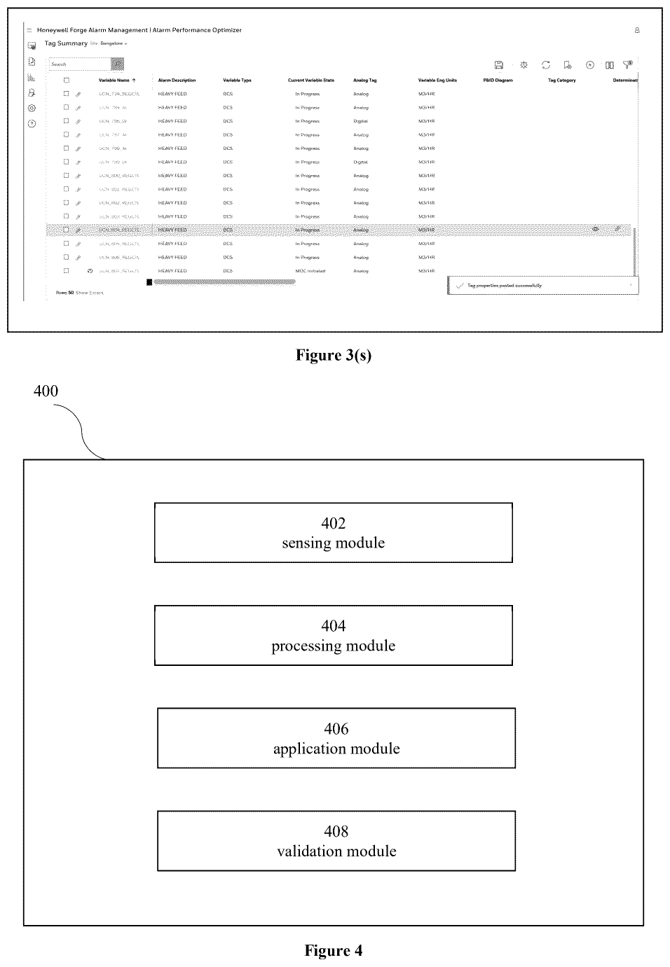

FIG. 3(a) illustrates an exemplary user interface 300 according to one or more embodiments of the disclosure. As shown in FIG. 3(a) and FIG. 3(b), a user interface indicating creation of tag template is indicated, according to the present disclosure. The tag template is created by providing name details such as “Logic tags reference”, description such as “template for logic tags” and search tag “LOGIC, Calc”, as shown in FIG. 3(b). These details help categorize and identify the tag template for future use. Users can search for templates based on criteria such as name, description, or search tag.

FIG. 3(c) of the user interface 300 displays the options to select the scope of items of the tag like modes of operations and alarms as part of the Template. Further, as shown in FIG. 3(d), the user also has the option to select properties along with modes of operations and alarms. Properties include but are not limited to alarm properties, boundary properties, and operational mode-specific settings. Some of the alarm properties are displayed in FIG. 3(d) are for example, time to respond, priority, alarm category, etc. FIG. 3(e) also displays various alarm properties, and boundary properties. The user may select all, deselect all or partial select the properties and create a tag template.

The creation of the alarm template is depicted in FIG. 3(f), according to an embodiment of the disclosure. The alarm templates are created in a similar manner as the tag templates. The alarm template is created by providing, for example, the name “OFF Norm Reference template”, a description such as “Off Norm Alarm Reference” and a search tag, “OFFNORM, NotNormal” as shown in FIG. 3(f), refer to step 204 for creation of alarm templates. The above-mentioned details help categorize and identify the alarm template for future use. The users can search for templates based on criteria such as name, description, or search tag. The users also have the option to choose which specific properties of the alarm should be included in the template like response fields, value fields etc. as shown in FIG. 3(g). The user may select all, deselect all or partial select the properties and create alarm template.

FIG. 3(h) of the user interface displays the option to manage templates both at the alarm level and tag level. The users may edit or modify the properties of alarm templates and tag templates created. Customizing templates within and across different sites helps in standardization of alarm settings and responses. FIGS. 3(i) and 3(j) display a user interface in which various properties of alarm templates and tag templates may be edited depending on the requirements of the system.

After creating templates at the tag level and the alarm level, as discussed in steps 204 to 212, the templates are applied to the destination alarm or tag for standardization. As shown in FIG. 3(k), the option Apply template is displayed. The user selects the tag or tags and selects the option Apply template as shown in FIG. 3(l), Accordingly, the tag template is applied.

As shown in FIG. 3(m), the alarm template is applied by selecting option Apply template. The user selects the alarm or alarms and selects option Apply template and as shown applies the selected alarm properties to the template. In this manner, as discussed above and as shown in FIGS. 3(k)-3(m), the templates are applied with a minimal number of user interactions to standardize the alarm settings across the selected alarms or tags.

FIGS. 3(n) and 3(o) displays user interface for copying of source tags and pasting copied properties to destination tags or target tags. As displayed in FIG. 3(n), the tag copy feature allows to quickly copy all the relevant properties for a tag. The copy operation just needs 2 clicks as shown, select the tag, and then click copy.

In an embodiment, for copying the tag properties, the user needs to select the source tag with rationalized alarm settings and then copy the source tag properties, including at least one of the alarm properties, boundary properties, and operational mode-specific settings as discussed in step 208 of FIG. 2. The various properties of the selected source tag are displayed in FIGS. 3(p)-(q) that need to be copied to the target tag.

The tag paste feature is displayed in FIG. 3(o). the users apply the copied source tag properties to one or more target tags as discussed in step 210 as discussed in FIG. 2. The users select the target tags for applying the copied properties. The criteria for selecting the target tag includes selecting tags that serve a similar function or role within the unit or system, tags that measure similar parameters or share redundant measurement units and tags that trigger similar alarms or alerts based on their measurements. Within a unit, there can be similar alarms or tags (measurements). These similar tags may share characteristics or properties that can be rationalized or standardized which ensures consistency and efficiency in managing tags across the system. During the process of applying the copied properties, the rationalized values, or properties from the source tag are accurately copied to the selected target tags.

Users have the option to choose specific properties from the copied properties to be applied to the target tags. Properties are categorized into groups like “Variable”, “Alarms”, “Boundaries”, “Variable Properties”, “Variable Notes”, and “Other parameters” as shown in FIG. 3(r).

The paste operation is executed as shown in FIG. 3(s) to replicate the rationalized settings from the source tag to the target tags. Once the fields are selected, the paste operation is performed, transferring the values from the source tag to the target tags.

An embodiment of this application further provides a non-transitory computer-readable medium. The computer-readable storage medium stores computer-readable instructions. When the computer-readable instructions are executed by a processor, the computer may implement technical solutions related to the rationalization of alarms in any one of the embodiments as shown in FIG. 1(a) to FIG. 2 in the foregoing method embodiments. The phrase “computer readable instructions” includes any type of computer code, including source code, object code, and executable code. The phrase “computer-readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable storage device.

FIG. 4 illustrates an alarm management system 400 for rationalizing alarms in a controlled environment according to an embodiment of the disclosure. The alarm management system 400 comprises a sensing module 402, a processing module 404, an application module 406, and a validation module 410. The sensing module 402 identifies one or more alarms associated with tags in the control system that require rationalization.

The processing module 404 creates an alarm template from existing alarm settings or selects a predefined alarm template that includes standardized properties and values. In an embodiment, the standardized properties and values include one or more of alarm response details, priority levels, and operational modes.

The application module 406 applies the created or selected alarm template to the identified one or more alarms. To apply the created or selected alarm template to the identified one or more alarms, the application module 406 is further configured to select the alarms or tags to which the template is to be applied, search the template to ensure it meets the required threshold, and apply the template with a minimal number of user interactions to standardize the alarm settings across the selected alarms or tags.

The processing module 404 is further configured to select a source tag with rationalized alarm settings and copy the source tag properties, including at least one of the alarm properties, boundary properties, and operational mode-specific settings.

The application module 406 further applies the copied source tag properties to one or more target tags, wherein each tag is associated with one or more alarms. In an embodiment, to apply the copied source tag properties to one or more target tags, the application module 406 is further configured to select the target tags for applying the copied properties, provide flexibility to choose specific properties from the copied properties to be applied to the target tags, and execute the paste operation to replicate the rationalized settings from the source tag to the target tags. The validation module 408 validates the applied target tags being consistent with the requirements of the control system.

In an embodiment, the processing module 404 is further configured to audit the changes made to each tag or alarm, capturing details of the applied template or copied properties and the source of the changes. In another embodiment, to audit the changes made to each tag or alarm, the processing module 404 is further configured to audit the created or selected alarm template.

In an embodiment, the processor module 404 is further configured to display the alarms and mode of operation to be copied for individual tags. In another embodiment, the processing module 404 is further configured to check if variable tags belong to the same alarm system. In another embodiment, the created template is flexible to include only specific modes of operations and specific alarm types.

The disclosed alarm rationalization method and system present a comprehensive approach to enhancing the efficiency and safety of industrial process control systems. By integrating the alarm rationalization device 120 into the broader operational framework of the process control system 100, as depicted in FIGS. 1(a) and 1(b), the system automates the identification and management of nuisance alarms. This device, equipped with a processor 122, memory 124, and input/output unit 126, collects and analyzes data from various sensors 102a and actuators 102b, as well as historical data stored in the historian 114. The collected data is processed to identify patterns of alarm occurrences, classify alarms based on their frequency and impact, and generate templates for optimized alarm settings.

The alarm rationalization method involves several key steps. Initially, the system collects data from the process control system 100 and applies algorithms to identify alarms that require rationalization. The device 120 then generates customizable templates for alarm settings, which can be adjusted by operators through the operator consoles 110. These templates ensure consistency across the system and facilitate the efficient management of alarms. Once the templates are configured, the new alarm settings are applied to the system 100, updating the controllers 106 and recalibrating the sensors 102a and actuators 102b as needed. The system monitors the effectiveness of the updated settings in real-time, providing feedback and enabling further adjustments to maintain optimal performance.

This approach offers several advantages, including the reduction of nuisance alarms, improved operational efficiency, and enhanced safety. By automating the rationalization process, the system reduces the time and effort required to manage alarms, allowing alarm experts and subject matter professionals to focus on critical plant operations and production activities. The standardized templates ensure a consistent approach to alarm management across different parts of the industrial plant, while the intuitive user interface supports easy customization and control. Overall, the disclosed method and system for alarm rationalization represent a significant advancement in industrial automation and control, contributing to the reliability and effectiveness of complex industrial processes.

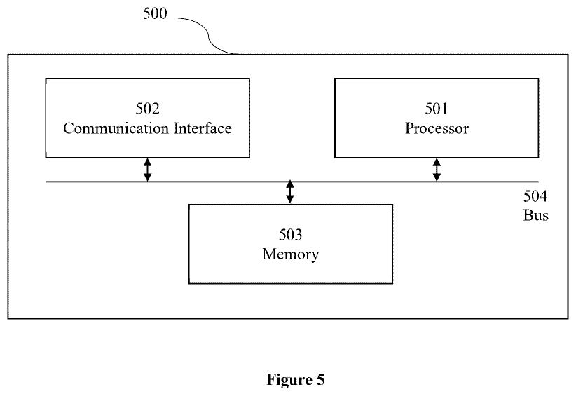

FIG. 5 illustrates a schematic diagram of another communication apparatus 500 according to an embodiment of the disclosure. The communication apparatus 500 includes a processor 501, a communication interface 502, and a memory 503. The processor 501, the communication interface 502, and the memory 503 may be connected to each other via a bus 504. The bus 504 may be a peripheral component interconnect (peripheral component interconnect, PCI) bus, an extended industry standard architecture (extended industry standard architecture, EISA) bus, or the like. The bus 504 may be classified into an address bus, a data bus, a control bus, and the like. For case of representation, the bus is represented by using only one line in FIG. 5, but it does not indicate that there is only one bus or one type of bus. The processor 501 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 503 may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

Usually, various embodiments of this disclosure may be implemented by hardware or a dedicated circuit, software, logic, or any combination thereof. Some aspects may be implemented by the hardware, and other aspects may be implemented by firmware or software, and may be performed by a controller, a microprocessor, or another computing device. Although aspects of embodiments of this disclosure are shown and described as block diagrams, flowcharts, or some other figures, it should be understood that the blocks, apparatuses, systems, technologies, or methods described in this specification may be implemented as, for example, non-limiting examples, hardware, software, firmware, dedicated circuits or logic, general-purpose hardware or controllers or other computing devices, or a combination thereof.

This disclosure further provides at least one computer program product tangibly stored on a non-transitory computer-readable storage medium. The computer program product includes computer-executable instructions, such as instructions included in a program module, which are executed in a device on a real or virtual processor of a target, to perform the processes/methods described above with reference to the accompanying drawings. Usually, a program module includes a routine, a program, a library, an object, a class, a component, a data structure, or the like that performs a particular task or implements a particular abstract data type. In various embodiments, functions of the program module may be combined or a function of the program module may be as needed. Machine-executable instructions for the program module may be executed locally or within a distributed device. In the distributed device, the program module may be located in local and remote storage media.

Computer program code for implementing the method disclosed in this disclosure may be written in one or more programming languages. The computer program code may be provided for a processor of a general-purpose computer, a dedicated computer, or another programmable data processing apparatus, so that when the program code is executed by the computer or the another programmable data processing apparatus, a function/operation specified in the flowchart and/or the block diagram is implemented. The program code may be completely executed on a computer, partially executed on a computer, independently performed as a software package, partially executed on a computer and partially executed on a remote computer, or completely executed on a remote computer or a server.

In context of this disclosure, the computer program code or related data may be borne in any appropriate carrier, so that the device, the apparatus, or the processor can perform various processing and operations described above. An example of the carrier includes a signal, a computer-readable medium, and the like. An example of the signal may include propagating signals in electrical, optical, radio, sound, or other forms, such as carrier waves and infrared signals.

The computer-readable medium may be any tangible medium that includes or stores a program used for or related to an instruction execution system, apparatus, or device. The computer-readable medium may be a computer-readable signal medium or a computer-readable storage medium. The computer-readable medium may include but is not limited to an electronic, magnetic, optical, electromagnetic, infrared, or semiconductor system, apparatus, or device, or any suitable combination thereof. A more detailed example of the computer-readable storage medium includes an electrical connection with one or more wires, a portable computer disk, a hard disk, a random access memory (RAM), a read-only memory (ROM), an erasable programmable read-only memory (EPROM or flash memory), an optical storage device, a magnetic storage device, or any suitable combination thereof.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method for rationalizing alarms and tags in a control system, comprising the steps of:
identifying one or more alarms associated with tags in the control system that require rationalization;
creating an alarm template from existing alarm settings or selecting a predefined alarm template that includes standardized properties and values;
applying the created or selected alarm template to the identified one or more alarms;
selecting a source tag with rationalized alarm settings and copying the source tag properties, including at least one of alarm properties, boundary properties, and operational mode-specific settings;
applying the copied source tag properties to one or more target tags, wherein each tag is associated with one or more alarms; and
validating the applied target tags being consistent with the requirements of the control system.

2. The method as claimed in claim 1, further comprising auditing the changes made to each tag or alarm, capturing details of the applied template or copied properties and the source of the changes.

3. The method as claimed in claim 1, wherein the standardized properties and values include one or more of alarm response details, priority levels, and operational modes.

4. The method as claimed in claim 1, wherein applying the created or selected alarm template to the identified one or more alarms comprises:
selecting the alarms or tags to which the template is to be applied;
searching the template to ensure it meets a required threshold; and
applying the template with a minimal number of user interactions to standardize the alarm settings across the selected alarms or tags.

5. The method as claimed in claim 1, wherein applying the copied source tag properties to one or more target tags comprises:
selecting the target tags for applying the copied properties;
providing flexibility to choose specific properties from the copied properties to be applied to the target tags; and
executing the paste operation to replicate the rationalized settings from the source tag to the target tags.

6. The method as claimed in claim 1, wherein applying the copied source tag properties to one or more target tags includes displaying the alarms and mode of operation to be copied for individual tags.

7. The method as claimed in claim 1, wherein applying the copied source tag properties to one or more target tags includes checking if variable tags belong to the same alarm system.

8. The method as claimed in claim 2, wherein auditing the changes made to each tag or alarm including auditing the created or selected alarm template.

9. The method as claimed in claim 1, wherein the created template is flexible to include only specific modes of operations and specific alarm types.

10. The method as claimed in claim 1, wherein the template may be created from released copy of a variable or newly created or modified release copy of the variable.

11. An alarm management system for rationalizing alarms in a control environment, comprising:
a memory;
a processor configured to be operatively associated with the memory, wherein the memory is configured to:
identify one or more alarms associated with tags in the control system that require rationalization;
create an alarm template from existing alarm settings or select a predefined alarm template that includes standardized properties and values;
apply the created or selected alarm template to the identified one or more alarms;
select a source tag with rationalized alarm settings and copy the source tag properties, including at least one of alarm properties, boundary properties, and operational mode-specific settings;
apply the copied source tag properties to one or more target tags, wherein each tag is associated with one or more alarms; and
validate the applied target tags being consistent with the requirements of the control system.

12. The alarm management system as claimed in claim 11, wherein the processor further configured to audit the changes made to each tag or alarm, capture details of the applied template or copied properties and the source of the changes.

13. The alarm management system as claimed in claim 11, wherein the standardized properties and values include one or more of alarm response details, priority levels, and operational modes.

14. The alarm management system as claimed in claim 11, wherein to apply the created or selected alarm template to the identified one or more alarms, the processor being configured to:
select the alarms or tags to which the template is to be applied;
search the template to ensure it meets the required threshold; and
apply the template with a minimal number of user interactions to standardize the alarm settings across the selected alarms or tags.

15. The alarm management system as claimed in claim 11, wherein to apply the copied source tag properties to one or more target tags, the processor being configured to:
select the target tags for applying the copied properties;
provide flexibility to choose specific properties from the copied properties to be applied to the target tags; and
execute the paste operation to replicate the rationalized settings from the source tag to the target tags.

16. The alarm management system as claimed in claim 11, wherein the processor being further configured to display the alarms and mode of operation to be copied for individual tags.

17. The alarm management system as claimed in claim 11, wherein the processor being further configured to check if variable tags belong to the same alarm system.

18. The alarm management system as claimed in claim 12, wherein to audit the changes made to each tag or alarm, the processor being further configured to audit the created or selected alarm template.

19. The alarm management system as claimed in claim 11, wherein the created template is flexible to include only specific modes of operations and specific alarm types.

20. A non-transitory computer-readable medium having stored thereon computer-readable instructions that, when executed by a processor, cause the processor to execute a method for rationalizing alarms and tags in a control system, comprising:
identifying one or more alarms associated with tags in the control system that require rationalization;
creating an alarm template from existing alarm settings or selecting a predefined alarm template that includes standardized properties and values;
applying the created or selected alarm template to the identified one or more alarms;
selecting a source tag with rationalized alarm settings and copying the source tag properties, including at least one of alarm properties, boundary properties, and operational mode-specific settings;
applying the copied source tag properties to one or more target tags, wherein each tag is associated with one or more alarms; and
validating the applied target tags being consistent with the requirements of the control system.
